(19) United States
(12) Patent Application Publication
(10) Pub. No.: US 2015/0237296 A1
(43) Pub. Date: Aug. 20, 2015

(54) RETROFIT COMBINATION VIDEO RECORDER AND MICROPHONE, WITH SCREEN DISPLAY AND INSTANT PLAYBACK, FOR FIRST-RESPONDER TYPE RADIOS

(71) Applicants: Jubal Ragsdale, Fayetteville, TN (US); Ken Dong Qiang Liu, Kingswood Villas (HK)

(72) Inventors: Jubal Ragsdale, Fayetteville, TN (US); Ken Dong Qiang Liu, Kingswood Villas (HK)

(21) Appl. No.: 14/691,333

(22) Filed: Apr. 20, 2015

Related U.S. Application Data
(60) Provisional application No. 62/090,089, filed on Dec. 10, 2014.

(51) Int. Cl. H04N 5/93; G11B 31/00; H04W 4/02

(52) U.S. Cl. CPC H04N 5/9305; H04W 4/02; G11B 31/006

(57) ABSTRACT

An apparatus including a first handheld device and a known radio pack. The first handheld device may include a radio microphone, and an integrated video recorder. The first handheld device communicates with the radio pack through the radio microphone and a communications link. The first handheld device may further include a global positioning satellite receiver configured to supply a global positioning satellite location of the first handheld device to the video recorder. The first handheld device may include a computer display screen and a play button; wherein the computer display screen communicates with the video recorder and displays videos recorded by the video recorder in response to selection of the play button. The first handheld device may further include a recording microphone different from the radio microphone; wherein the recording microphone communicates with the video recorder and to cause audio to be recorded and linked to recorded video.

### CROSS REFERENCE TO RELATED APPLICATION(S)

The present application claims the priority of U.S. provisional patent application Ser. No. 62/090,089, titled “Retrofit Combination Video Recorder and Microphone, with Screen Display and Instant Playback, for First-Responder Type Radios”, filed on Dec. 10, 2014.

### FIELD OF THE INVENTION

This invention relates generally to two-way radio microphones.

### BACKGROUND OF THE INVENTION

Presently, first responders such as police officers, firemen, paramedics, etc., utilize conventional radio kits while out in the field. Such conventional radio kits usually include a microphone on a cable and a radio pack. The microphone is usually clipped to a location on the user's torso, and has controls for the radio pack. The actual radio pack that handles processing and transmission is usually worn on a user's belt. The cable connects the microphone and the radio pack.

However, such conventional radio systems do not currently incorporate the use of video. Oftentimes, video recordings would be useful for after-action analysis and for archival purposes. Helmet cameras would be an alternative; however, first responders are often already overburdened and do not need an additional encumbrance.

### SUMMARY OF THE INVENTION

At least one embodiment of the present invention relates generally to a retrofit microphone head. In at least one embodiment it is meant to be used with radios of the type used by first responders. This microphone head has an integrated video recorder with instant playback capability. The objective of at least one embodiment of the present invention is to allow first responders to record their activities for after-action analysis and archival purposes.

At least one embodiment of the present invention provides a retrofit device which replaces the existing microphone head of a conventional radio system utilized by first responders. Notably, at least one embodiment of the present invention, would not be considered additional equipment for such personnel; it serves to replace existing equipment while providing additional functionality. The relatively similar weight thus mitigates issues related to equipment encumbrance.

In at least one embodiment, the present invention has integrated audio-visual recording capability as its primary distinction from conventional systems. There is a video recorder built into the device, in at least one embodiment, with lens and storage media. Furthermore, in at least one embodiment, there is an additional integrated display screen and/or computer monitor on the rear. This allows for instant playback in the field without the need to transfer video/audio files to an external storage system. If so desired however, in at least one embodiment, there is data transfer capability to allow easy export of video/audio files.

In at least one embodiment, an apparatus is provided comprising a first handheld device comprising a radio microphone, and a video recorder integrated with the radio microphone. The apparatus may further include a known radio pack. The first handheld device may be configured to communicate with the radio pack through a communications link.

The apparatus may further include a communications cable having a first end connected to the first handheld device and a second opposing end connected to the radio pack; and wherein the communications cable provides the communications link.

The first handheld device may further include a global positioning satellite receiver; wherein the global positioning satellite receiver is configured to supply a global positioning satellite location of the first handheld device to the video recorder. The video recorder may include a computer processor which embeds the global positioning satellite location of the first handheld device in a video produced by the video recorder. The first handheld device may further include a computer display screen and a play button; wherein the computer display screen communicates with the video recorder and displays videos recorded by the video recorder in response to selection of a play button.

The first handheld device may further include a recording microphone which is different from the radio microphone; wherein the recording microphone is configured to communicate with the video recorder and to cause audio to be recorded and linked to recorded video. The first handheld device may further include a speaker which is configured to be used for both playback of video with linked audio recorded by the video recorder and for radio communications provided through the radio pack.

In at least one embodiment a method is provided comprising using a first handheld device including a radio microphone and a video recorder to communicate wirelessly by using the radio microphone to communicate through a radio pack via communications link; and using the first handheld device to record video; and wherein the video recorder is integrated with the radio microphone. The first handheld device may be as previously described and may be connected by a communications cable having a first end connected to the first handheld device and a second opposing end connected to the radio pack; and wherein the communications cable provides the communications link.

### BRIEF DESCRIPTION OF THE DRAWINGS

FIG. 1 is a simplified flowchart of an apparatus, method, and/or system in accordance with at least one embodiment of the present invention;

FIG. 2 is a simplified flowchart depicting instant playback capability, with both display and speaker components;

FIG. 3 is a simplified flowchart depicting data transfer capability;

FIG. 4 is a simplified flowchart depicting a recording process pipeline, from lens to storage;

FIG. 5 is a flowchart depicting an LED status process;

FIG. 6 is a frontal view of a first device, which may include the components of FIG. 1.

FIG. 7 is a rear view of the first device of FIG. 6;

FIG. 8 is a first side view of the first device of FIG. 6;

FIG. 9 is a second side view of the first device of FIG. 6;

FIG. 10 is a top side view of the first device of FIG. 6;

FIG. 11 is a bottom side view of the first device of FIG. 6; and

FIG. 12 shows the first device of FIG. 6 connected by cable to a walkie/radio or radio pack worn on a belt of a first responder or individual person.

### DETAILED DESCRIPTION OF THE DRAWINGS

All illustrations of the drawings are for the purpose of describing selected versions of the present invention and are not intended to limit the scope of the present invention. Walkie-talkies, portable radios, and other such handheld devices come in a plurality of forms. Such various embodiments may contain minor variations, while still keeping true to the descriptions contained in this disclosure and the functionality of the present invention.

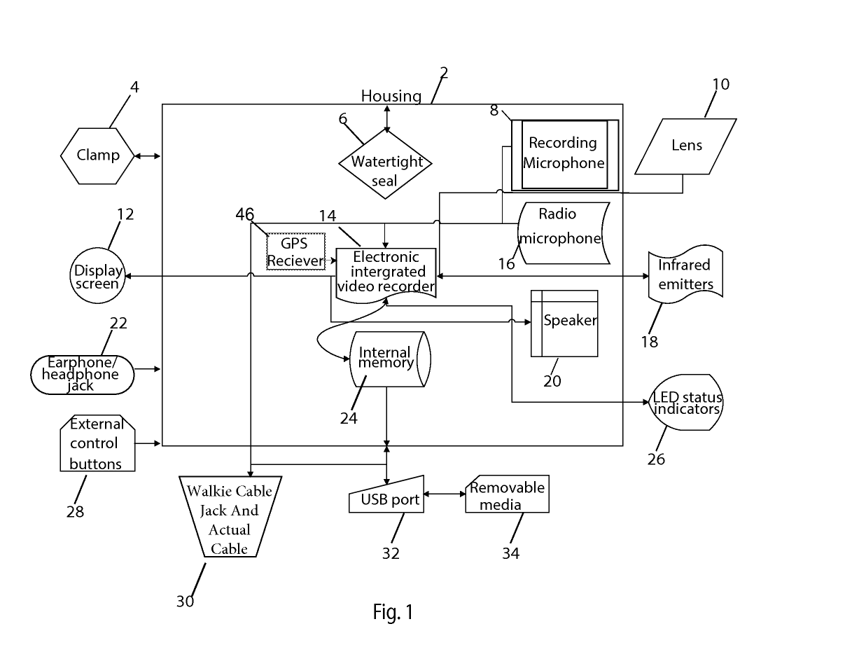

FIG. 1 is a simplified block diagram and flow chart 1 of an apparatus, method, and/or system in accordance with at least one embodiment of the present invention. The diagram 1 includes housing 2, clamp 4, watertight seal 6, recording microphone 8, lens 10, display screen or computer monitor 12, electronic integrated video recorder 14, radio microphone 16, infrared emitters 18, speaker 20, earphone/headphone jack 22, internal memory 24, LED status indicators 26, external control buttons 28, walkie cable jack and actual cable 30, USB port 32, removable media 34, and GPS receiver 46. The video recorder 14 may include a computer processor which implements a computer program stored in internal computer memory 24.

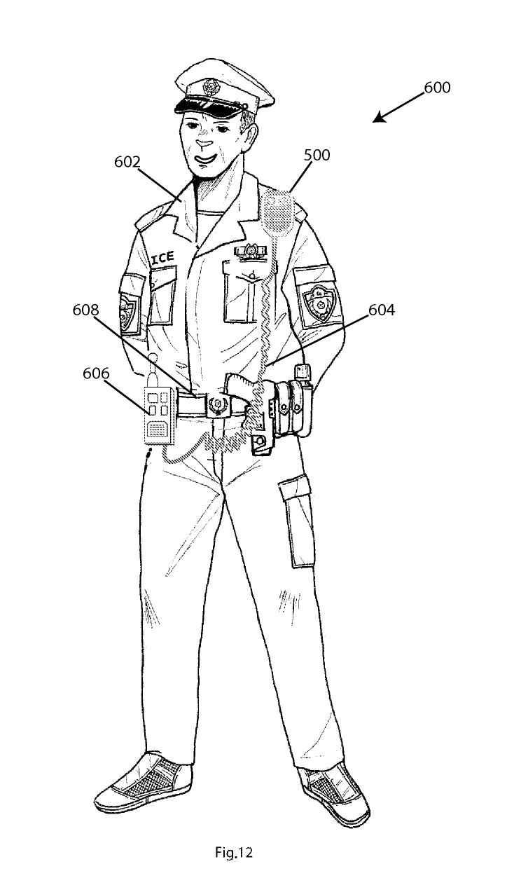

In at least one embodiment of the present invention, a microphone head or first device 500 shown in FIG. 12 includes the housing 2, the watertight seal 6, an electronic integrated video recorder 14, a lens 10, a recording microphone 8, a separate radio microphone 16, a speaker 20, a display screen 12, internal memory 24 or removable media 34, infrared emitters 18, a USB port 32, LED status indicator(s) 26, a walkie cable pair with both jack and cable 30, a earphone/headphone jack 22, a clamp 4, a set of external control buttons 28, and the GPS receiver 46. Some of these components are comprised of other sub-components which will be discussed in detail later.

Notably, at least one embodiment of the present invention is meant to be used in conjunction with a radio pack, such as radio pack 606 shown in FIG. 12. As mentioned, these radio packs are part of conventional first responder radio systems. Such radio packs handle the majority of transmission and communications functionality. They are often worn on belts.

In at least one embodiment of the present invention, a first device 500, shown in FIG. 12, is connected by cable 604 to a walkie/radio or radio pack 606 worn on a belt 608 of a first responder or individual person 602. The first device 500 of FIG. 12, which typically includes the components of FIG. 1, is typically attached to such a walkie/radio 606, and may need to be attached to such a walkie/radio 606, in at least one embodiment, to function.

In at least one embodiment, a major component of the first device 500 is the housing 2 shown in FIG. 1. The housing 2 may contain many, if not most, of the major components, and/or may act as a frame for external components.

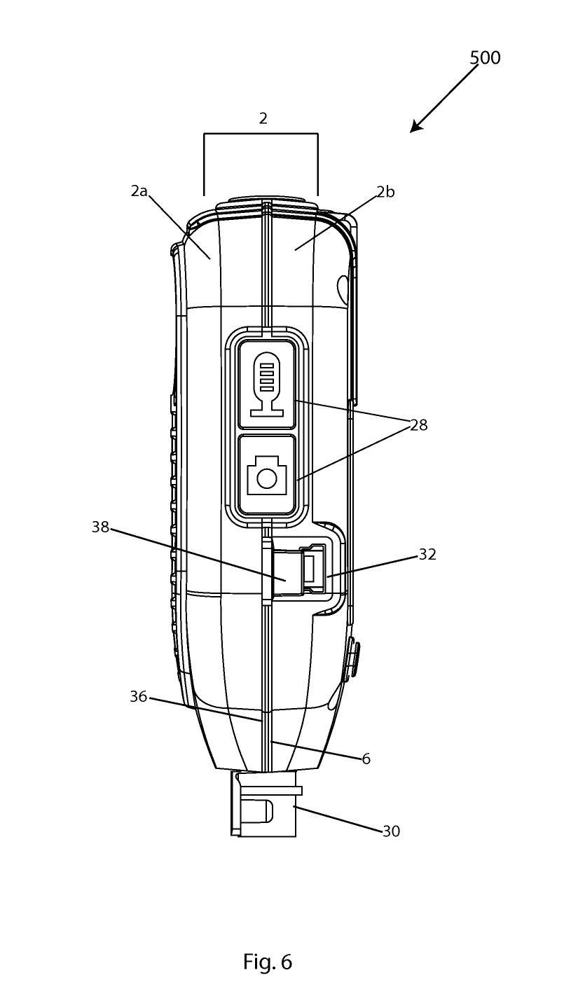

The housing 2 may itself be comprised of a first half 2a and a second half 2b as shown in FIG. 6. The first half 2a may be for the front of the first device 500, in accordance with an embodiment of the present invention. The first device 500 is shown in various views in FIGS. 6-11.

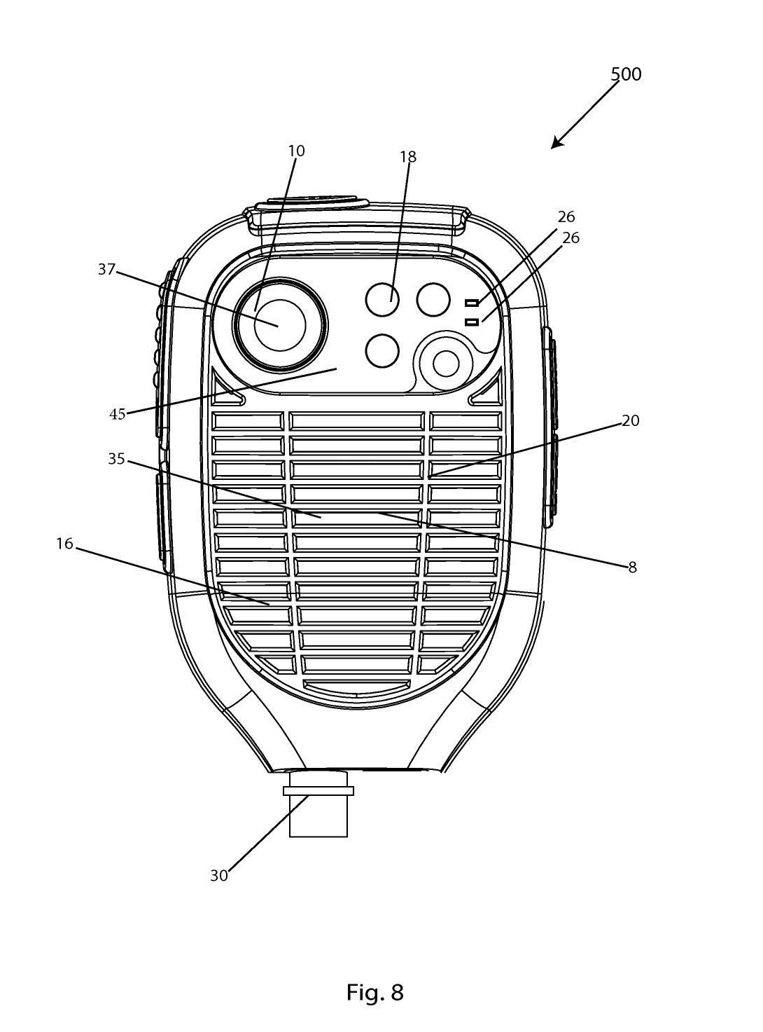

The housing 2 of the first device 500, has accommodating holes/grilles/indentations/slots 35 shown in FIG. 8 to accommodate the other components of the first device 500, as shown for example in FIG. 6.

The second half 2b of the housing 2, shown in FIG. 6, is for the back/rear of the first device 500, in accordance with an embodiment of the present invention. The second half 2b of the housing 2 also has accommodating holes/grilles/indentations/slots 35 to accommodate the other components of the first device 500, as shown in FIG. 8.

Specific locations of the holes/grilles/indentations/slots 35 are discussed later in this disclosure as each component is described.

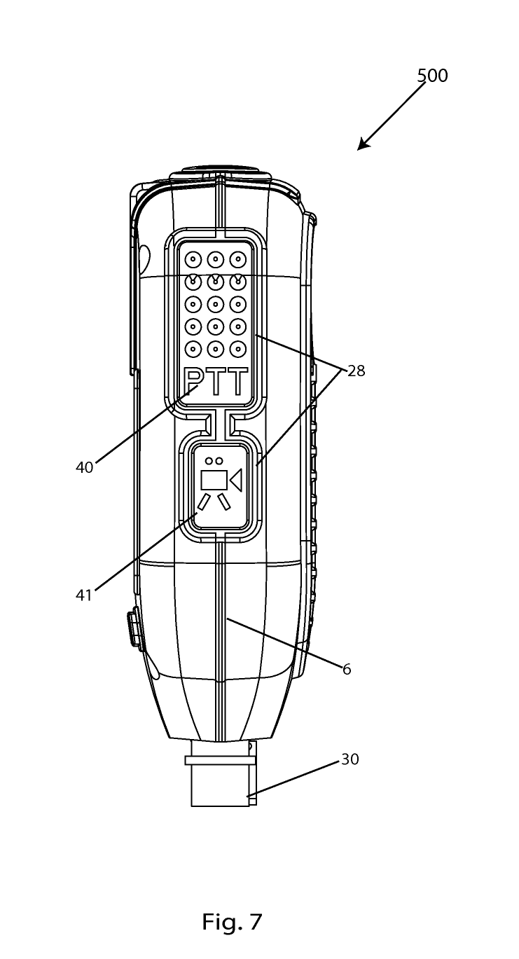

The first half 2a and second half 2b of the housing 2 are connected by a watertight seal 6, shown in FIGS. 6 and 7, and discussed later.

The watertight seal 6 of the first device 500 typically includes rubber or other suitable material and forms a watertight bond between the first and second halves, 2a and 2b, respectively. The watertight seal 6 is located at the seam 36, shown in FIG. 6, between the first half 2a and the second half 2b of the housing 2. The seal 6 may be comprised of any watertight material suitable for use with electronic components. This may include but is not limited to: caulking, glue, filler, and other sealant materials. Alternative embodiments may have varying levels of water resistance at different pressures, depending on environmental needs of the embodiment and the changing industry.

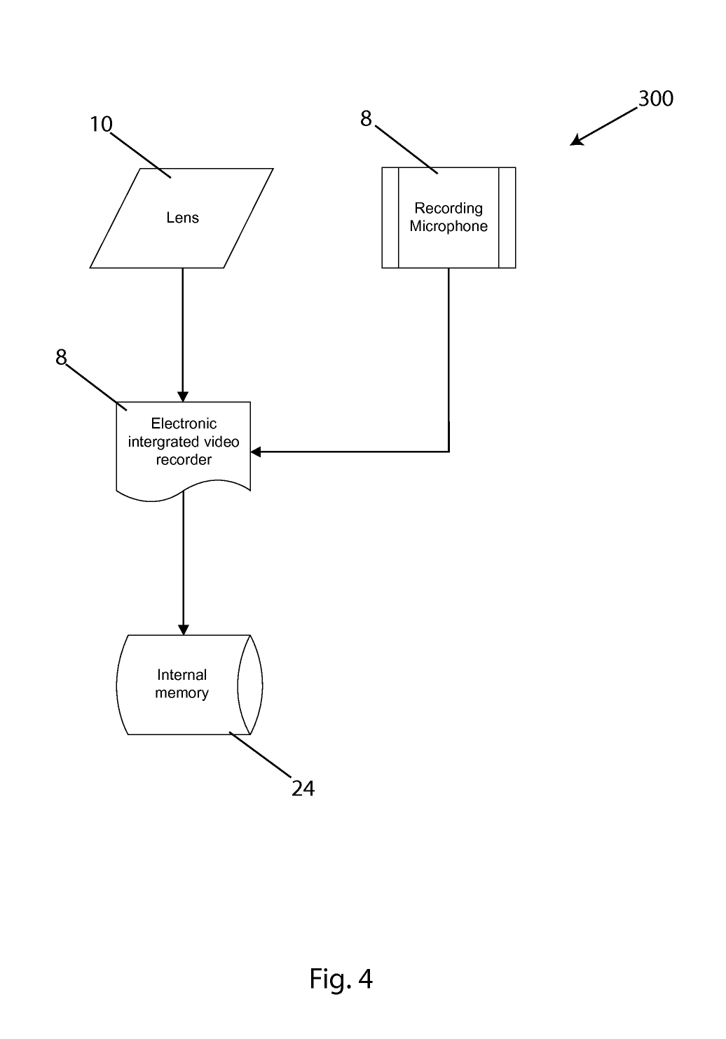

Another component of the first device 500 is the electronic integrated video recorder 14. In a preferred embodiment, of the present invention, the video recorder 14 is a built-in video recorder which is fully electronic with no moving parts. The video recorder 14 may include a computer processor and computer memory. The video recorder 14 handles the video processing from the visual input 37 shown in FIG. 8. In at least one embodiment, the lens 10 is not part of the recorder 14, and is discussed separately. The video recording process is depicted by the diagram 300 in FIG. 4.

Visual data received by the lens 10 (the lens 10 may be a camera lens), may be recorded by video recorder 14. Audio data received by the recording microphone 8, shown in FIG. 4, may be recorded by the video recorder 14. Data received from the internal memory 24 may be recorded by the video recorder 14 and stored on removable digital media 34.

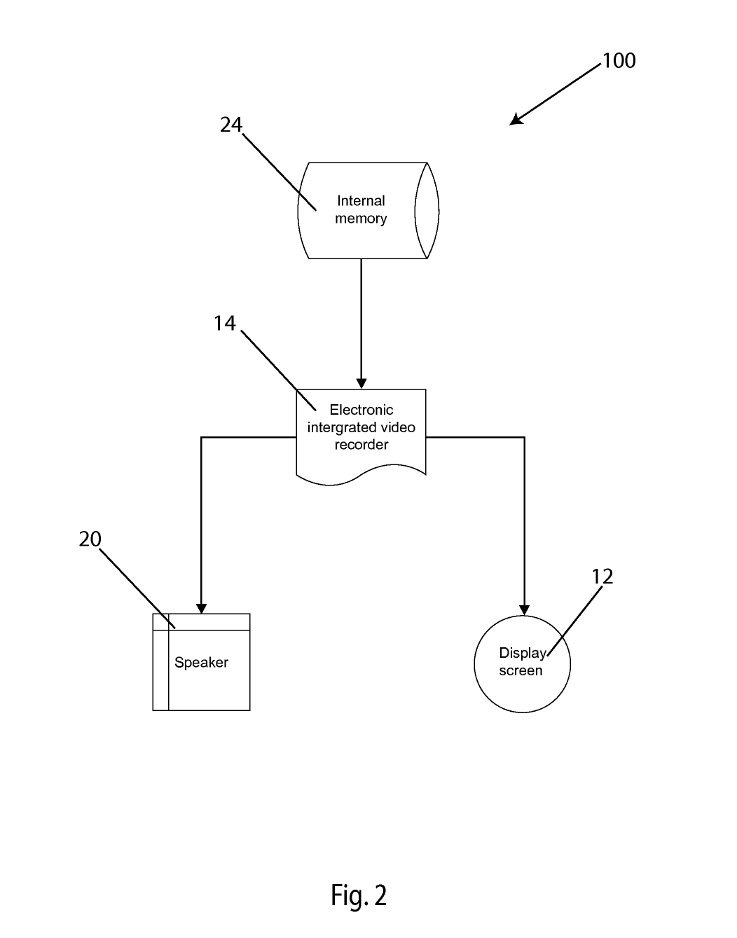

Notably, the video recorder 14, has an internal computer memory, or memory 24 which has an instant playback capability/sub-process as shown by the diagram 200 of FIG. 2. This will output the video and audio to the display screen 12 and the speaker 20, respectively. The display screen 12 and the speaker 20 are discussed in detail later in the present application.

In alternative embodiments of the present invention, the video recorder 14 may include some moving parts, such as lens focusing mechanisms or pan/tilt/zoom mechanisms.

Another component of one or more embodiments of the present invention is the lens 10 shown in FIG. 1. The lens 10, may be located on the front of the first device 500 shown in FIG. 6. facing outward from the user while the first device 500 is worn on a user, such as user 602 as shown in FIG. 12. The lens 10 is fitted so it can see through a corresponding opening in the housing 2.

Another component of one or more embodiments of the present invention is the recording microphone 8. The recording microphone 8 is used in recording audio for the aforementioned electronic integrated video recorder 14. The microphone 8 helps record audio from the surrounding environment. Notably, the recording microphone 8, in at least one embodiment, is separate and distinct from the radio microphone 16; the radio microphone 16 is used exclusively for radio communications, in at least one embodiment.

Another component of one or more embodiments of the present invention is the radio microphone 16. The radio microphone 16, in at least one embodiment, is used exclusively for radio communication. To reiterate, in at least one embodiment, the microphone 16 is separate and distinct from the recording microphone 8 used for recording audio from the user's surroundings.

The speaker 20, in at least one embodiment, is the primary sound emitting device for the first device 500. The speaker 20 is used both during responses during radio communications, as well as video playback.

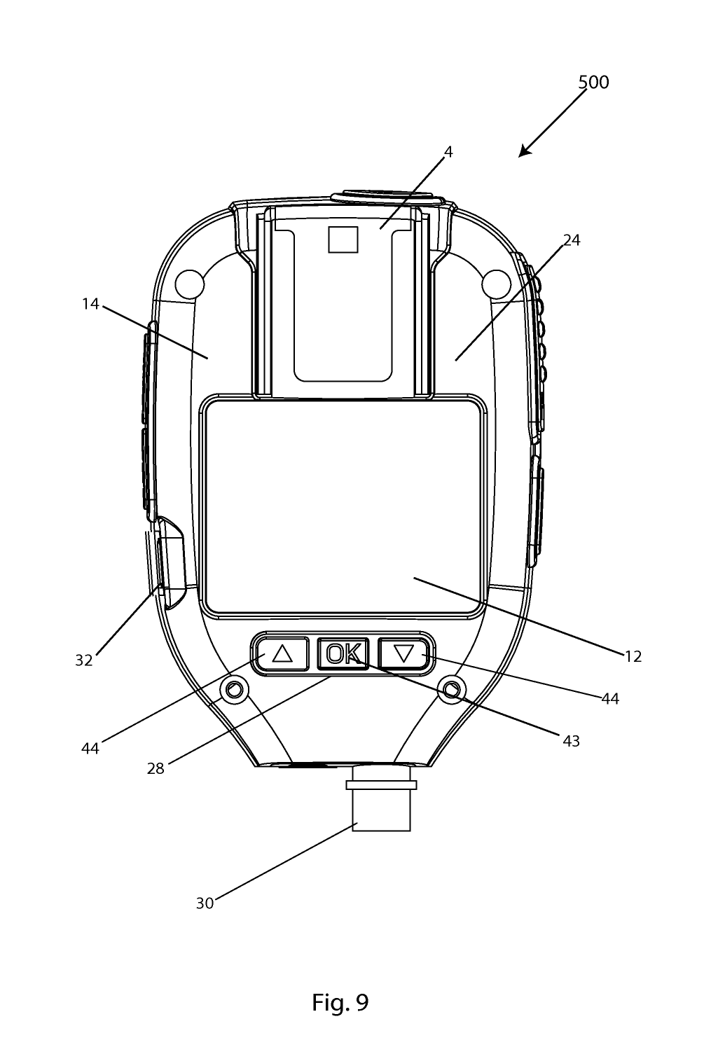

In FIG. 9, in at least one embodiment, the display screen 12 is located on the back of the first device 500, fitted into the second half 2b of the housing 2, as shown in FIG. 7. As mentioned with reference to the video recorder 14, the first device 500 has video playback capability. When the user plays videos, they will be shown on the display screen 12 as programmed by a computer program stored in internal memory 24 and implemented by a computer processor of the video recorder 14. In a preferred embodiment, the display screen 12 is an integrated 1.5″ LCD (liquid crystal display) screen. Alternative embodiments of the present invention may use different types of screens, such as plasma, or screens of varying dimensions.

The removable media 34 is the data storage device or system for one or more embodiments of the present invention. The removable media 34 can be a SD (Secure Digital) card system, internal hard drive, removable media such as a USB (universal serial bus) flash drive, or some combination thereof. Alternative embodiments of the present invention may use forms of solid state media not explicitly mentioned here.

The set of optional infrared emitters 18 are used for night vision. The emitters 18 are located on the front of the first device 500, integrated with the first half 2a of the housing 2 shown in FIG. 8. In a preferred embodiment, these infrared emitters 18 are IR (infrared) LEDS (light emitting diodes). Alternative embodiments of the present invention may use different forms of emitters which perform similar functions. To emphasize, the infrared emitters 18 are optional, and not all embodiments of the present invention may possess infrared emitters.

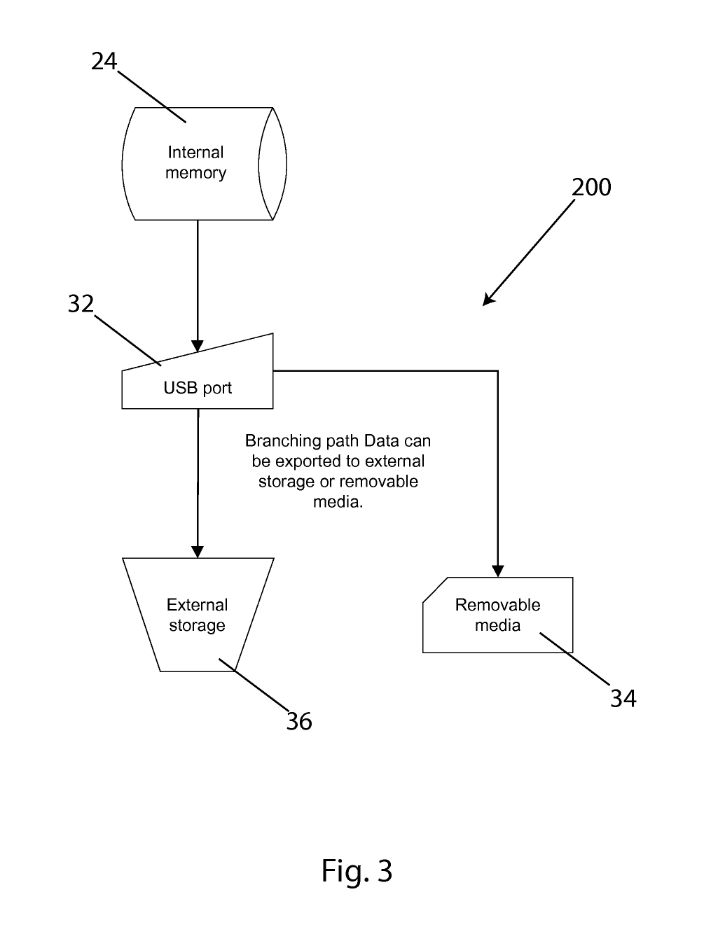

The USB port 32 may be a standard Universal Serial Bus port. The port 32 is shown in FIG. 6. The port 32 may be used for data transfer to-and-from the aforementioned internal memory 24 or removable media 34. This process is depicted by diagram 200 of FIG. 3. The USB port 32 may or may not come with an attached flap 38 shown in FIG. 6 to preclude the entrance of dirt and other particulate matter. Alternative embodiments of the present invention may use different types of data transfer such as IEEE 1394, commonly termed Firewire (trademarked), or other forms of data transfer such as WiFi, Bluetooth, etc. The present invention is not limited to one form of data transfer capability, and may include multiple forms in different embodiments.

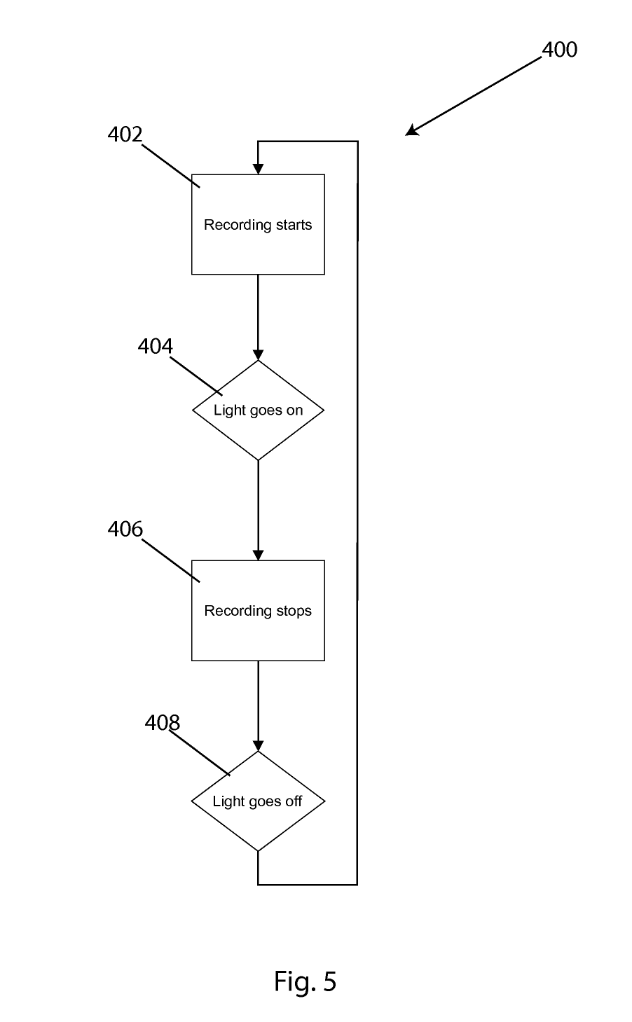

The set of LED status indicator(s) 26, shown in FIG. 8, may be comprised of a single LED status indicator or a plurality of indicators. These indicators reflect the condition or status of various components of the first device 500. For example, an indicator of indicator(s) 26 may indicate whether or not the video recorder 14 is in operation. The operation of indicator(s) 26 is shown by FIG. 5. In FIG. 5, recording starts at step 402 at the video recorder 14. At step 404 an indicator of 26, such as an LED may light up or go on, to indicate that the video recorder 14 is recording. At step 406, the recording by video recorder 14 may stop. At step 408, the light of indicator 26 may go off in response to the recorder 14 stopping.

Additional indicators of indicator(s) 26 may display the power status or other statuses, depending on the embodiment of the present invention. Alternative embodiments of the present invention may include different forms of indicators not explicitly listed here.

The pair of walkie cable pair and the jack and actual cable 30 may include a standard jack used for conventional first-responder type radio packs. The cable of 30 may be an industry-standard cable that connects to the radio pack.

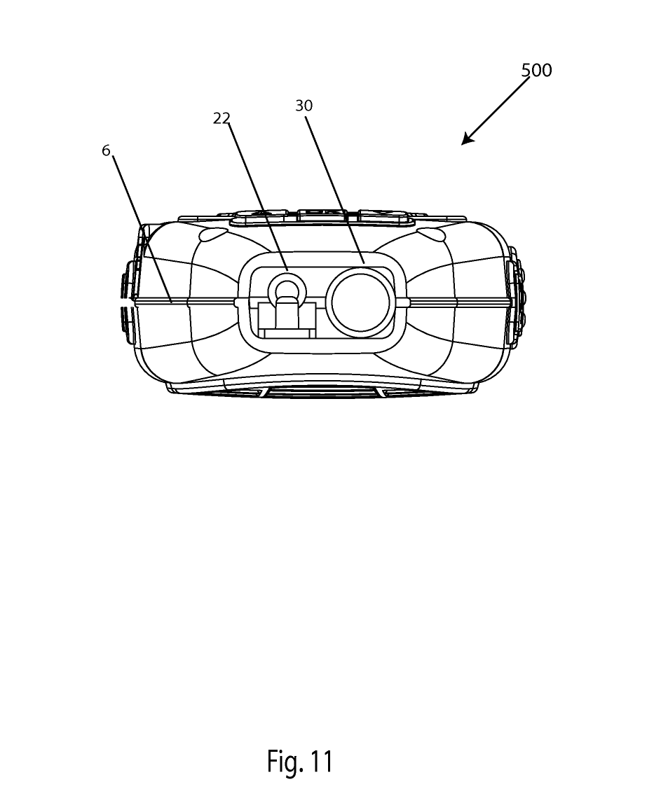

The earphone/headphone jack 22 is located on the bottom of the housing 2 as shown in which FIG. 11 In a preferred embodiment, the jack 22 is located directly in the center of the bottom of the housing 2, in between the first half and second half of the housing 2. This would also be directly along the watertight seal 6. This is depicted in FIG. 11.

In a preferred embodiment, the jack 22 is an industry-standard 3.5 mm audio jack. Future or alternative embodiments may use different audio jacks.

The clamp 4 may be located on the rear of the first device 500, in accordance with at least one embodiment of the present invention, integrated with the second half 2b of the housing 2. The clamp 4 may be used for attaching the present first device 500 to a user's torso area. For example, the clamp 4 may be attached to the user's shoulder loop, pocket, etc. as shown in FIG. 12. Alternative embodiments of the present invention may use different attachment methods.

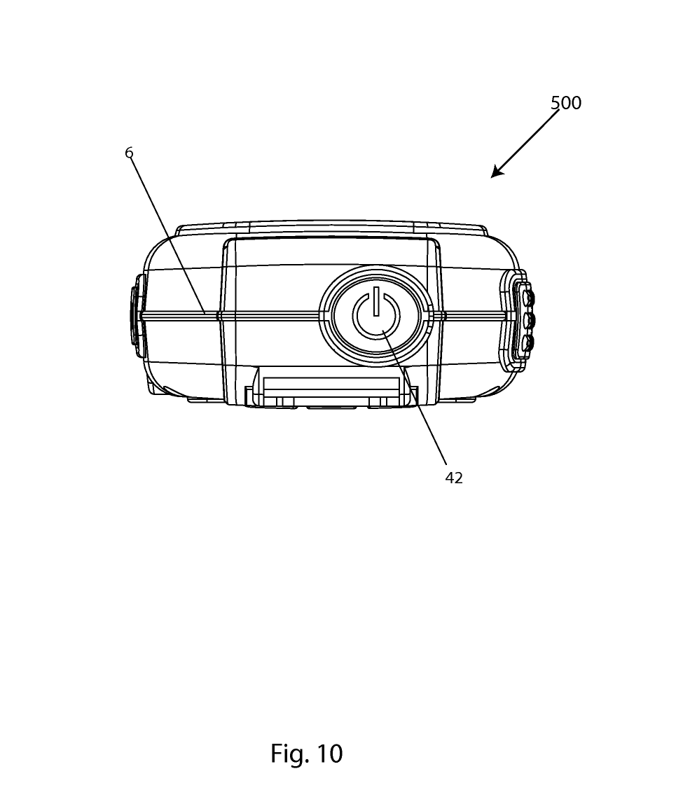

The set of external control buttons 28, in at least one embodiment, would be used by the user to activate either the radio microphone 16, and to start/stop/rewind/fast-forward video recordings (and their linked audio which is automatically recorded by recording microphone 8 with the video recorded. The buttons 28 and their arrangements for a preferred embodiment are listed as follows. There may be a talk button 40, shown in FIG. 7, which when depressed allows someone to use the radio microphone 16 to communicate using the radio pack 606 located on the first side of the housing 2. This would be located in between the first half 2a and second half 2b of the housing 2, along the watertight seal 6. There is typically an REC/Down button 41, shown in FIG. 7, on the second side of the housing 2. The REC/Down button 41, is used to record video when depressed (and surrounding audio with recording microphone 8) would be located in between the first half 2a and second half 2b of the housing 2, along the watertight seal 6. This is depicted in FIG. 7. There is typically a Power button 42, for turning on the overall power to the first device 500, on the top side of the first device 500 shown in FIG. 10. This would be located in between the first half 2a and second half 2b of the housing 2, along the watertight seal 6.

There is typically a Play button 43, labeled “OK” on the rear on the housing 2. This would be located below the LCD Screen. The play button 43 can be pressed to play a video and its linked audio as recorded by recording microphone 8 on the display screen 12, recorded by the video recorder 14. All video and linked audio recorded by video recorder 14 and recording microphone 8 may be stored in internal memory 24 and/or other computer memory.

There are typically selector buttons 44, on the rear of the housing 2. The selector buttons 44 are typically located on the rear of the housing 2, along the watertight seal 6. The selector buttons 44 may be located adjacent to the Play button 43. The selector button 44 with the down arrow in FIG. 9 may be used to fast forward a video recorded by the video recorder 14, on the screen 12. The selector button 44 with the up arrow in FIG. 9 may be used to rewind a video recorded by the video recorder 14, on the screen 12.

Alternative embodiments of the present invention may include additional or fewer buttons, depending on the needs of the embodiments and the changing industry. In addition, the button placements may vary between embodiments of the invention.

There are certain attributes of the invention which may vary in future or alternative embodiment of the invention, or which warrant further explanation. Herein are some of the descriptions of such attributes.

In the invention's preferred embodiment, the communications method utilizes radio. However, other embodiments of the present invention may utilize other forms of communication such as cellular networks.

One or more embodiments of the present invention may support streaming of video or audio.

One or more embodiments of the present invention may have data synchronization capability with related systems, such as with a police cruiser camera system.

As briefly mentioned earlier, other embodiments of the invention may include some forms of wireless data transfer, such as Bluetooth or WiFi. Other wireless technologies may also be used.

Herein follows a description of the interaction of the major components, as seen in FIG. 1. The housing 2 (of first device 500 in FIGS. 6-11) contains the majority of the other components of the first device 500, or acts as a frame for the external components. A watertight seal 6 keeps water from penetrating the interior of the housing 2. The electronic video recorder 14 is located inside the housing 2. The lens 10 typically protrudes from the video recorder 14, and is integrated with a fitted aperture. The lens 10 faces outward of the housing 2.

The recording microphone 8, separate radio microphone 16, speaker 20, infrared emitters 18, and LED status indicators 26, are all located inside the housing 2 with appropriate grilles/slots, etc. to accommodate their outward-facing nature. The walkie cable jack of 30 and earphone/headphone jack 22 are similarly integrated. The walkie cable of 30 is plugged into the walkie cable jack of 30.

There is also internal memory 24 such as an SD (secure digital) card, hard drive and/or a USB slot for removable media 34. There is a display screen 12 on the back of the camera FIG. 9.

The clamp 4 attaches to a user's garment or other torso equipment during use. The external control buttons 28 allow the user to manipulate the first device 500 of FIGS. 6-11.

Herein follows a description of the components as the first device 500 is in use. In usage, the user, such as 602 in FIG. 12, first plugs the non-housing end of the walkie cable 604 into a typical radio pack 606. The radio pack 606 is usually attached to the user's belt 608. In the event of water usage, the watertight seal 6 will protect the components of the first device 500.

The other end of the walkie cable 604 is plugged into the walkie cable jack of 30 in the housing 2 of the first device 500. The user 602 manipulates the external control buttons 28 to use the functions of the first device 500. Visual images are received through the lens 10 and processed by the video recorder 14, and stored into the internal memory 24 or removable media 34. The recording microphone 8 takes in the surrounding audio as input and the audio is linked with the visual images and stored in the internal memory 24 or removable media 34, for example, in response to the REC/down button 41 shown in FIG. 7. The user 602 can manipulate the controls or buttons 28 to use the separate radio microphone 16 to communicate with colleagues. The speaker 20 of the first device 500 projects audio to the user, from either radio communications or recorded video with linked recorded audio. The display screen 12 is used for playback in the field, after activity has occurred. The screen 12 works in conjunction with the speaker 20 during playback. This is depicted in FIG. 2.

Infrared emitters 18 are used in low-light situations. The USB port 32 can be used after activity has occurred to transfer files to an external storage system. The LED status indicators 26 notify the user and possibly observers of pre-specified conditions, such as operation of the video recorder 14.

In alternative embodiments, the first device 500 may not be connected by cable 604 and may communicate with the radio pack 606 in a wireless manner, such as by bluetooth, Wi-Fi, or other wireless communication as may come available.

The first device 500 may have an integrated GPS (global positioning satellite) receiver 45 that receives the GPS location of the first device 500, and wherein a computer processor of the video recorder 14 embeds the GPS location in a video taken by the electronic integrated video recorder, as programmed by a computer program stored in internal memory 24, for example. The GPS location may be displayed on the display monitor or screen 12, such as example New York, N.Y.

The display screen 12 may be eliminated in one or more embodiments to reduce size and weight.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a first handheld device comprising
a radio microphone;
and a video recorder integrated with the radio microphone;
a radio pack; and
wherein the first handheld device is configured to communicate with the radio pack through a communications link.

2. The apparatus of claim 1 further comprising
a communications cable having a first end connected to the first handheld device and a second opposing end connected to the radio pack; and
wherein the communications cable provides the communications link.

3. The apparatus of claim 1 wherein
the first handheld device further includes a global positioning satellite receiver;
wherein the global positioning satellite receiver is configured to supply a global positioning satellite location of the first handheld device to the video recorder;
and wherein the video recorder includes a computer processor which embeds the global positioning satellite location of the first handheld device in a video produced by the video recorder.

4. The apparatus of claim 1 wherein
the first handheld device further includes a computer display screen and a play button;
wherein the computer display screen communicates with the video recorder and displays videos recorded by the video recorder in response to selection of a play button.

5. The apparatus of claim 1 wherein
the first handheld device further include a recording microphone which is different from the radio microphone;
wherein the recording microphone is configured to communicate with the video recorder and to cause audio to be recorded and linked to recorded video.

6. The apparatus of claim 1 wherein
the first handheld device further includes a speaker which is configured to be used for both playback of video with linked audio recorded by the video recorder and for radio communications provided through the radio pack.

7. A method comprising:
using a first handheld device including a radio microphone and a video recorder to communicate wirelessly by using the radio microphone to communicate through a radio pack via communications link; and
using the first handheld device to record video; and
wherein the video recorder is integrated with the radio microphone.

8. The method of claim 7 wherein
the radio microphone is connected by a communications cable having a first end connected to the first handheld device and a second opposing end connected to the radio pack; and
wherein the communications cable provides the communications link.

9. The method of claim 7 wherein
the first handheld device further includes a global positioning satellite receiver;
wherein the global positioning satellite receiver is configured to supply a global positioning satellite location of the first handheld device to the video recorder;
and wherein the video recorder includes a computer processor which embeds the global positioning satellite location of the first handheld device in a video produced by the video recorder.

10. The method of claim 7 wherein
the first handheld device further includes a computer display screen and a play button;
wherein the computer display screen communicates with the video recorder and displays videos recorded by the video recorder in response to selection of a play button.

11. The method of claim 7 wherein
the first handheld device includes a recording microphone which is different from the radio microphone; and
further comprising using the recording microphone to communicate with the video recorder and to cause audio to be recorded and linked to recorded video.

12. The method of claim 7 wherein
the first handheld device includes a speaker which is configured to be used for both playback of video with linked audio recorded by the video recorder and for radio communications provided through the radio pack.
